(19) United States
(12) Patent Application Publication
(10) Pub. No.: US 2014/0130548 A1
(43) Pub. Date: May 15, 2014

(54) METHOD OF MANUFACTURING A TOUCH PANEL

(71) Applicants: Yuh-Wen Lee, Zhubei City (TW); Yea-Wan Chen, Hsinchu City (TW)

(72) Inventors: Yuh-Wen Lee, Zhubei City (TW); Yea-Wan Chen, Hsinchu City (TW)

(21) Appl. No.: 13/672,711

(22) Filed: Nov. 9, 2012

(51) Int. Cl. C03C 21/00; C03C 15/00; C03B 21/02

(52) U.S. Cl. CPC C03C 21/002; C03B 21/02; C03C 15/00
USPC 65/30.14; 65/105; 65/31

(57) ABSTRACT

The present disclosure relates to a method of manufacturing a touch panel, and more particularly, to a manufacturing method capable of strengthening the strength of the touch panel. The method comprises: sinking and then strengthening a glass substrate, and then conducting a manufacturing process of placing a sensing electrode array. Finally, the glass substrate is cut and produced into several touch panels, each having strengthening properties.

This application claims the benefit of Chinese application No. 201110379405.7, filed on Nov. 9, 2011.

### BACKGROUND

1. Technical Field

The present disclosure relates to a manufacturing method of a touch panel. More particularly, the present disclosure relates to a manufacturing method capable of strengthening strength of touch panel.

2. Description of the Related Art

Currently available touch panels, except those having a substrate that is placed with a sensing electrode array, are designed with a protective cover leas. With the development of touch technology, a sensing electrode array can be directly placed on a protective cover leas to form a touch panel with a single plate (the so-called touch on lens (TOL)). Because the cover lens for protection must avoid damages caused by external force influence, glass-strengthened treatment is an essential and important process in the manufacturing process of a touch panel.

FIG. 1 shows a flowchart of a traditional method of strengthening glass strength.

Step 1: Cutting: Using a blade wheel, a cutter, or a laser beam of numerical control instrument, a mother glass is cat into several pieces of subordinate glasses based on the needed scale specification of glass.

Step 2: Trimming: The computerized numerical control instrument is used for grinding four side peripheries of the foregoing cut subordinate glasses to remove burrs and thin cracks caused by the cutting procedure, and trim the edging shape containing chamfer angles to reduce the chance of generating ruptures in assembling with other mechanism parts due to collision and extrusion.

Step 3: Strengthening: Chemically strengthening means is adopted to conduct surface strengthening on the foregoing trimmed subordinate glasses.

However, in the manufacturing process of the touch panel with a single plate, the step of placing sensing electrode array is performed only after the cover lens is processed by the foregoing strengthening treatment so as to avoid destruction of the sensing electrode array because of the chemical strengthening process. But if the manufacturing process of the touch panel with a single plate adopts the foregoing traditional glass strengthening method, only one piece of touch panel with single plate can be patterned at a time, thus resulting in lower production efficiency and incapability of mass production.

### SUMMARY OF THE INVENTION

In view of this, the present disclosure is mi improved manufacturing process directed to design an inclined plane of chamfer angle and then conduct the steps of strengthening, placing sensing electrode array, and cutting, in sequence, thereby solving the problem of the incapability of mass production.

A method of manufacturing a touch panel is provided in accordance with an embodiment of the present disclosure, the method comprises the steps of: sinking to form at least one groove on a glass substrate, wherein the groove comprises a base side and two inclining lateral sides; next, strengthening the surface of the glass substrate; subsequently, cutting the glass substrate according to the position of the base side.

Further, the grooves are paired and sunken correspondingly so as to be formed on an upper surface and a lower surface of the glass substrate.

Further, the base side is a fiat surface or a curved concave surface.

Further, the glass substrate is sunken to form the groove through etching, carving, or molding mechanism.

Further, the step of strengthening the glass substrate comprises adopting the means of chemical strengthening.

Further, the step of cutting the glass substrate comprises forming a cut plane.

Further, the inclining lateral sides are separately connected between the surface of glass substrate and the cut plane, to form a chamfer angle.

Further, after the step of cutting the glass substrate, the method further comprises: smoothing the cut plane.

Further, after the step of strengthening the surface of the glass substrate, the method further comprises: placing a sensing electrode array on the surface of the glass substrate.

As mentioned above, since the glass substrates can be placed with the sensing electrode array only once before cutting the glass substrates, design of the present disclosure can be applied to the manufacturing process for mass production, making the manufactured touch panel with a single plate have strengthening properties of chamfer angles and chemical strengthened.

The above mentioned technical method is supplemented for illustration with reference to the following drawings, embodiments, and schemas.

### BRIEF DESCRIPTION OF THE DRAWINGS

For those skilled in the art, numerous embodiments and drawings described below are for illustration purpose only and do not limit the scope of the present disclosure in any manner.

FIG. 1 shows a flowchart of a traditional method of strengthening glass strength;

FIG. 2 shows a flowchart concerning an embodiment of a method of manufacturing a touch panel according to the present disclosure;

FIG. 3 shows a schematic diagram concerning a structural embodiment of a glass substrate corresponding to the steps shown in FIG. 2; and

FIG. 4 shows a top view of a schematic diagram of an embodiment concerning placement of a sensing electrode array on a glass substrate according to the present disclosure.

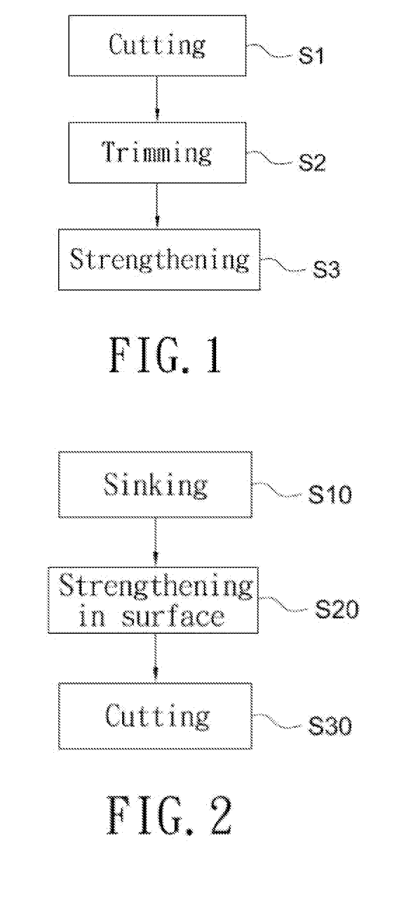

### DETAILED DESCRIPTION OF THE EMBODIMENTS

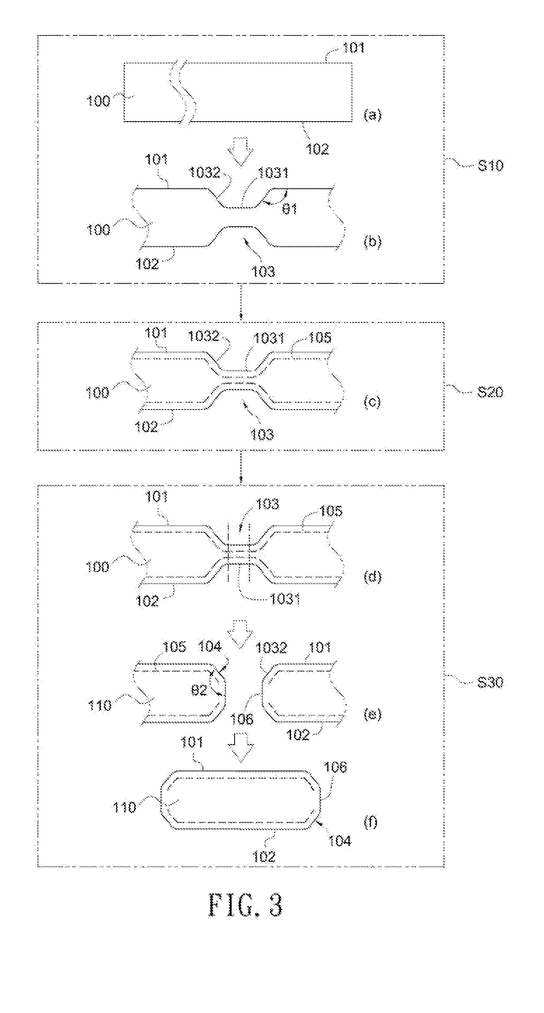

Please refer to FIG. 2 and FIG. 3, wherein FIG. 2 shows a flowchart concerning an embodiment of a method of manufacturing a touch panel according to the present disclosure. FIG. 3 comprises structures from (a) to (f), which respectively show schematic diagrams of structures corresponding to the steps shown in FIG. 2. As shown in FIGs. the method of manufacturing the touch panel of the present embodiment comprises the steps of:

Step S10: Sinking: Based on the scale specification of the needed touch panel, conducting a machining process of sinking, so as to form at least one groove 103 on a glass substrate 100 to delimit several areas as aligned in an array on the glass substrate 100, wherein each groove 103 (as shown in FIG. 3) comprises a base side 1031 and two inclining lateral sides 1032. The machining process of sinking, described in the present embodiment, can, for example, as shown through structures (a) and (b) of FIG. 3, include etching a plane glass substrate 100 by adopting chemicals or laser to form the groove 103. Certainly, in practice, the machining process of sinking can also carve the plane glass substrate 100 to form the groove 103 by using a mechanical cutter or the machining process of sinking can be conducted by adopting a mechanism of molding the glass substrate 100 directly to shape the grooves 103 in one piece, which is not limited by the present disclosure.

As shown in FIG. 3, the grooves 103 of the present embodiment are paired and sunken simultaneously to be formed on an upper surface 101 and a lower surface 102 of the glass substrate 100 for further forming inverted frameworks. The base side 1031 of the groove 103 can be designed with a flat surface or a curved concave surface in accordance with the actual processing requirement. The included angle θ1 joining the inclining lateral sides 1032 of the groove 103 and the upper surface 101, or joining the inclining lateral sides 1032 of the groove 103 and the lower surface 102 of the glass substrate 100 presents an angle more than 90 degree, thereby reducing the situation of concentrated stresses.

Step S20: Strengthening in surface: As shown in structure (c) of FIG. 3, the present embodiment conducts a surface strengthening treatment on the overall piece of the sunken glass substrate 100 by adopting means such as chemical strengthening, thereby letting the surface areas of the glass substrates 100 (including the upper surface 101, the lower surface 102, the base side 1031, and the two inclining lateral sides 1032 of each groove 103) to form an ion exchange layer 105 due to the occurrence of the ion exchange phenomena, thereby achieving the purpose of strengthening the glass substrates 100.

Subsequently, after completion of the surface strengthening treatment, because the present embodiment is used for illustrating the manufacturing process of the touch panel, the upper surface 101 and/or the lower surface 102 of the strengthened glass substrates 100 can be placed to form a sensing electrode array through the so-called patterning process. As a person skilled in the art can understand the detailed procedures of the patterning process, the same are not repeated again. The sensing electrode array can be a construction composed of a single conductive layer or dual conductive layers, which is not limited herein.

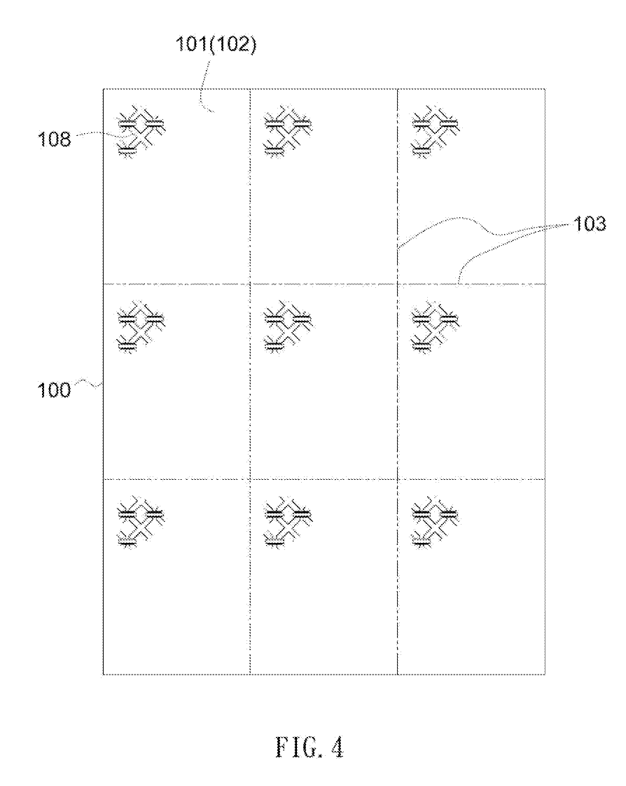

FIG. 4 is a top view of a schematic diagram of an embodiment concerning the placement of a sensing electrode array on the glass substrate according to the present disclosure. Since the present embodiment of FIG. 4 depicts a sensing electrode array 108 constructed by a single conductive layer, the sensing electrode array 108 is formed on the upper surface 101 or the lower surface 102 of the glass substrate 100. As shown in FIG. 4, although the glass substrate 100 is delimited to several areas aligned in an array due to the grooves 103, the patterning process can be conducted for all delimited areas on the glass substrate 100 only once to achieve the purpose of mass production.

In addition, in an embodiment, of the present disclosure, before the placement of the sensing electrode array, and either before or after the step of surface strengthening, treatments such as anti-glare and anti-bacteria can be conducted on the surface of the glass substrate 100 to let the glass substrate 100 be used for protection and have more efficient effects of anti-glare and anti-bacteria.

Steps of FIG. 2 can be repeated if desired. Step S30: Cutting: As shown in the structures from (d) to (f) of FIG. 3, the present embodiment conducts cutting and machining for the glass substrates 100 placed with sensing electrode array by adopting a numerical control (NC) instrument. Specifically, the present embodiment cuts the glass substrate 100 by using a blade wheel, a cutter or a laser beam of the numerical control instrument. Further, the step S30 cuts the glass substrate 100 based on the position of the base side 1031 for removing the base side 1031, and further forms a cut plane 106 on each touch panel 110 that is cut out of glass substrate 100. The cut plane 106 joins the inclining lateral side 1032, and angle θ2 is formed between them with an angle of more than 90 degree to reduce the situation of concentrated stresses.

In addition, in accordance with an embodiment of the present disclosure, upper surface 101. and lower surface 102 of glass substrate 100 can respectively form a. chamfer angle 104. also referred to as C angle, with the cut plane 106 through the design of the preformed inclining lateral sides 1032, thereby reducing the chances of generating ruptures due to collision and extrusion caused by the touch panel 110 assembled with any mechanism part.

Incidentally, the sunken degree of the groove 103 of the present embodiment is not limited. For instance, a better design can be to make the distance between two corresponding upper and lower grooves 103 to become as short as possible, i.e., letting the length of the cut plane 106 to become shorter and shorter, such that it is convenient for executing the cutting step.

In addition, if the cutting step causes generation of burr edges and fine cracks on the cut plane 106, the present embodiment can further conduct a smoothing treatment for the cut plane 106 by using a glazing wheel or other flattening tools of the computerized numerical control (CNC) instrument, so as to get rid of the burr edges and the fine cracks.

A person skilled in the art can implement the present disclosure in accordance with the detailed disclosure made previously and manufacture the touch panel 110 with a single plate that retains strength. Strength described in the present disclosure generally refer to the strength of curving resistance, strength of compression, and strength of tensile resistance, which can prevent permanent deformation or damage when the touch panel 110 is subjected to external forces.

In a preferred embodiment of the present disclosure, inclined planes of needed chamfer angles are formed on a glass substrate before cutting the glass substrate, subsequent to which surface strengthening of the whole piece of the glass substrate is conducted, after which finally the sensing electrode array is placed and cut such that the touch panel with single plate is manufactured as has the properties of strengthening. In addition, since the present disclosure aims at conducting the machining only once for all delimited areas (touch panels) on the glass substrate before cutting the glass substrate during the strengthening process or during the process of placing the sensing electrode array, it is more suitable for mass production of the touch panel to provide the functions of protection and touch sensing.

While certain embodiments have been shown and described, various modifications and substitutions may be made thereto without departing from the spirit and scope of the disclosure. Therefore, it is to be understood that the present disclosure has been described by way of illustration and not limitations.

What is claimed is:

1. A method of manufacturing a touch panel, comprising:
sinking to form at least one groove on a glass substrate, wherein, the groove comprises a base side and two inclining lateral sides;
strengthening surface of the glass substrate; and
cutting the glass substrate based on position of the base side.

2. The method of manufacturing the touch panel of claim 1, wherein the grooves are paired and sunken, simultaneously on an upper surface and a lower surface of the glass substrate.

3. The method of manufacturing the touch panel of claim 1, wherein the base side is a flat surface or a curved concave surface.

4. The method of manufacturing the touch panel of claim 1, wherein the glass substrate is sunken to form the groove through etching, carving or molding mechanism.

5. The method of manufacturing the touch panel of claim 1, wherein the step of strengthening the glass substrate adopts a means of chemical strengthening.

6. The method of manufacturing the touch panel of claim 1, wherein the step of cutting the glass substrate further comprises forming a cut plane.

7. The method of manufacturing the touch plane of claim 6, wherein the inclining lateral sides are connected between surface of the glass substrate and the cut plane to form a chamfer angle.

8. The method of manufacturing the touch panel of claim 6, wherein after the step of cutting the glass substrate, the method further comprises: smoothing the cut plane.

9. The method of manufacturing the touch panel of claim 1, wherein after the step of strengthening the glass substrate, the method further comprises: placing a sensing electrode array on the surface of the glass substrate.

10. The method of manufacturing the touch panel of claim 9, wherein before the step of placing the sensing electrode array, the method further comprises: conducting an anti-glare and/or an anti-bacteria treatment on the glass substrate.
